(19) United States
(12) Patent Application Publication
(10) Pub. No.: US 2004/0266407 A1
(43) Pub. Date: Dec. 30, 2004

(54) Mobile phone, telecommunication system and method for automatically downloading multimedia data from receiving part

(75) Inventors: Sang-man Lee, Osan-si (KR); Hyo-sik Bang, Sungnam-si (KR); Ho-seok Yoon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/765,565

(22) Filed: Jan. 28, 2004

(30) Foreign Application Priority Data
Jan. 28, 2003 (KR) 10-2003-0005498

(51) Int. Cl. H04Q 7/20

(52) U.S. Cl. 455/414.1; 455/414.3; 455/414.4

(57) ABSTRACT

A mobile phone, telecommunication system, and method for automatically downloading multimedia data from a receiving part is disclosed. One aspect of the method comprises transmitting a call signal by a sending mobile phone and receiving the signal by a receiving mobile phone; defining a channel to a telecommunication network; and transmitting, by the receiving mobile phone and receiving, downloading and storing by the sending mobile phone, multimedia data, previously configured and stored in the receiving mobile phone. Another aspect of the method comprises transmitting, by a sending mobile phone, a call signal through a telecommunication network; detecting, by the telecommunication network, the call signal and notifying a multimedia data-providing server of the detection results; and, in response to the notification, transmitting, by the server, and receiving, downloading and storing by the sending mobile phone, the multimedia data, previously configured and stored in the server to the sending mobile phone.

This application claims the priority of Korean Patent Application No. 10-2003-0005498 filed on Jan. 28, 2003 in the Korean Intellectual Property Office, the disclosure of which is incorporated herein in its entirety by reference.

### BACKGROUND OF THE INVENTION

1. Field of Invention

The present invention generally relates to the field of telecommunications systems. In particular, the present invention relates to a mobile phone, a telecommunication system and a method for automatically downloading multimedia data from a receiving part.

2. Description of the Related Art

Inventions relating to services for transmitting and receiving multimedia data in a telecommunication system, between a sending phone and a receiving phone are disclosed in Korean Laid-Open Patent Publication No. 2002-0061700, entitled “Method of operating multimedia mailbox for mobile phone” (“the '700 publication”); No. 2001-0048179, entitled “Telecommunication system and method with a function of outputting message instead of ringback tone” (“the '179 publication”); and No. 2001-0093615, entitled “Video transmitting method for use in case of call-in-absence or in receiving video call as voice call, using video files stored in terminal or memory provided by communication service provider” (“the '615 publication).

The '700 publication discloses a method of operating a multimedia mailbox, wherein a mobile communication system receives a call signal from a caller, checks whether a call recipient is in a state capable of receiving the call, and, if the recipient is not in a state where the call can be received, transmits multimedia information configured by the recipient to the caller's terminal, instead of using a conventional voice mail box. However, according to this method, the multimedia mailbox is operated only when the recipient is in a state where a call cannot be received, such as a case where the recipient does not receive the call or the recipient's line is busy.

The '179 publication discloses a telecommunication system and a method, wherein, when a caller makes a phone call, a voice message, which a recipient has stored in a voice message creation unit of a switching system, is output to the caller's terminal, instead of a conventional ringback tone. FIG. 1 shows the configuration of a telecommunication system such as the one disclosed in the '179 publication.

Referring to FIG. 1, a sending part comprises a terminal 10, a switch 20, and a ringback tone creation unit 25, and a receiving part comprises terminals 50 and 60, a switch 30, and a ringback tone creation unit 35. The switch 30 is provided with a voice message creation unit 40, which is connected to the switches 20 and 30 on the inside or outside of the switches, or which is provided by a service provider. A voice message is stored by a recipient in the voice message creation unit 40. When a call is made through the sending part's terminal 10, the voice message creation unit 40 outputs the voice message to the sending part's terminal 10, rather than the ringback tone creation units 25 and 35 creating conventional ringback tones. However, the telecommunication system and method are simply to output a voice message or image information instead of a conventional ringback tone and the sending part's terminal 10 does not download and execute multimedia files only by making a phone call.

The inventions disclosed in the publications have a problem in that multimedia data from the receiving part cannot be automatically downloaded and executed by merely making a phone call to the receiving part's terminal that is subscribed to a multimedia data-providing service.

### SUMMARY OF THE INVENTION

An object of the present invention is to provide a mobile phone, a telecommunication system, and a method for automatically downloading multimedia data from a receiving part, wherein a user of a sending part's mobile phone can automatically download multimedia data from a receiving part's mobile phone, which is subscribed to a multimedia data-providing service and which stores the multimedia data therein, by merely making a phone call to the receiving part's mobile phone.

Another object of the present invention is to provide a mobile phone, a telecommunication system, and a method for automatically downloading multimedia data from a receiving part, wherein a user of a receiving part's phone configures multimedia data in a multimedia data server rather than his/her own phone and wherein a caller can automatically download the multimedia data from the server by merely making a phone call to the receiving part's phone, regardless of the kind of receiving part's phone.

According to one exemplary aspect of the present invention, there is provided a sending part's mobile phone capable of automatically downloading multimedia data from a receiving part's mobile phone, comprising a transceiver means, for transmitting a call signal to the receiving part's mobile phone through a telecommunication network or for receiving the multimedia data stored in a storage means of the receiving part's mobile phone; a storage means for storing the received multimedia data; an application for executing the multimedia data to be output; and a control means for determining whether the receiving part's mobile phone is subscribed to a multimedia data-providing service. The control means includes an application-management module for determining the kind of multimedia data, connecting the multimedia data to the application, and managing and controlling the application.

According to another exemplary aspect of the present invention, there is provided a telecommunication system for automatically downloading multimedia data from a receiving part, comprising a multimedia data-providing server for determining whether a sending part's mobile phone is capable of downloading and executing the multimedia data, and of transmitting the multimedia data, previously stored by a user of a receiving part's phone, to the sending part's mobile phone; the receiving part's phone configuring a multimedia data-providing service and registering it in the multimedia data-providing server; the sending part's mobile phone downloading the multimedia data, previously configured and stored in the multimedia data-providing server, and connecting the downloaded multimedia data to an application to execute the multimedia data; and a telecommunication network for connecting a call signal transmitted from the sending part's mobile phone to the receiving part's phone so as to define a channel, and for detecting the transmitted call signal and then determining whether the receiving part's phone is subscribed to the multimedia data-providing service. If it is determined that the receiving part's phone is subscribed to the multimedia data-providing service, the telecommunication network notifies the server of the fact that the receiving part's phone is subscribed to the service.

According to a further exemplary aspect of the present invention, there is provided a method for automatically downloading multimedia data from a receiving part's mobile phone in a telecommunication system including a sending part's mobile phone, the receiving part's mobile phone, and a telecommunication network, comprising transmitting, by a transceiver means of the sending part's mobile phone, a call signal through the telecommunication network; receiving, by a transceiver means of the receiving part's mobile phone, the call signal transmitted through the telecommunication network and defining a channel to the telecommunication network; transmitting, by the receiving part's mobile phone, the multimedia data, which was previously configured and stored in a storage means of the receiving part's mobile phone by a user of the receiving part's mobile phone, from the receiving part's mobile phone to the transceiver means of the sending part's mobile phone from when the channel is defined; and downloading, by the transceiver means of the sending part's mobile phone, the transmitted multimedia data and storing the data in a storage means of the sending part's mobile phone.

According to a further exemplary aspect of the present invention, there is provided a method for automatically downloading multimedia data from a multimedia data-providing server in a telecommunication system which includes including a sending part's mobile phone, a receiving part's phone, a telecommunication network, and the multimedia data-providing server comprising transmitting, by a transceiver means of the sending part's mobile phone, a call signal through the telecommunication network; detecting, by the telecommunication network, the transmitted call signal and notifying the server of the detection results; transmitting, by the server, the multimedia data, previously configured and stored in the server by a user of the receiving part's phone, from the server to the transceiver means of the sending part's mobile phone in response to the notification; and downloading, by the transceiver means of the sending part's mobile phone, the multimedia data transmitted from the server and storing the data in a storage means of the sending part's mobile phone.

### BRIEF DESCRIPTION OF THE DRAWINGS

These and other features, aspects, and advantages of the present invention will become better understood with reference to the following description, appended claims, and accompanying drawings, which should not be read to limit the invention in any way, in which:

FIG. 1 is a configuration of a conventional telecommunication system with a function of outputting a voice message instead of a ringback tone;

FIG. 2 shows operations of a system for downloading multimedia data from a receiving part's mobile phone according to a first exemplary embodiment of the present invention;

FIG. 3 shows operations of a system for downloading multimedia data from a multimedia data-providing server according to a second exemplary embodiment of the present invention;

FIG. 4 is a block diagram showing a configuration of a sending part's mobile phone for downloading the multimedia data according to the first and second exemplary embodiments of the present invention;

FIG. 5 is a block diagram showing a configuration of a receiving part's mobile phone that is subscribed to a multimedia data-providing service and automatically transmits the multimedia data according to the first exemplary embodiment of the present invention;

FIG. 6 is a block diagram of the multimedia data-providing server according to the second exemplary embodiment of the present invention;

FIG. 7 is a flowchart illustrating a method of automatically downloading the multimedia data from the receiving part's mobile phone according to the first exemplary embodiment of the present invention; and

FIG. 8 is a flowchart illustrating a method of automatically downloading the multimedia data from the multimedia data-providing server according to the second exemplary embodiment of the present invention.

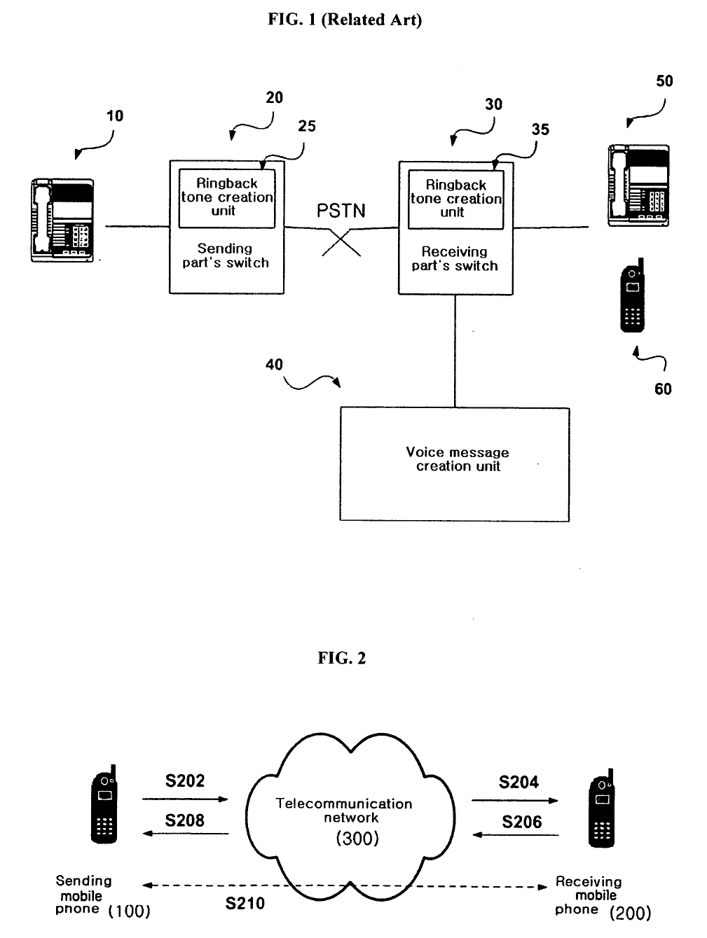

### DETAILED DESCRIPTION OF THE ILLUSTRATIVE, NON-LIMITING EMBODIMENTS OF THE INVENTION

Exemplary embodiments of the present invention will be explained in further detail with reference to the accompanying drawings.

FIGS. 2, 4, 5, and 7 illustrate the present invention according to a first exemplary embodiment, in which a sending part's mobile phone automatically downloads multimedia data from a receiving part's mobile phone, in which the multimedia data was previously stored.

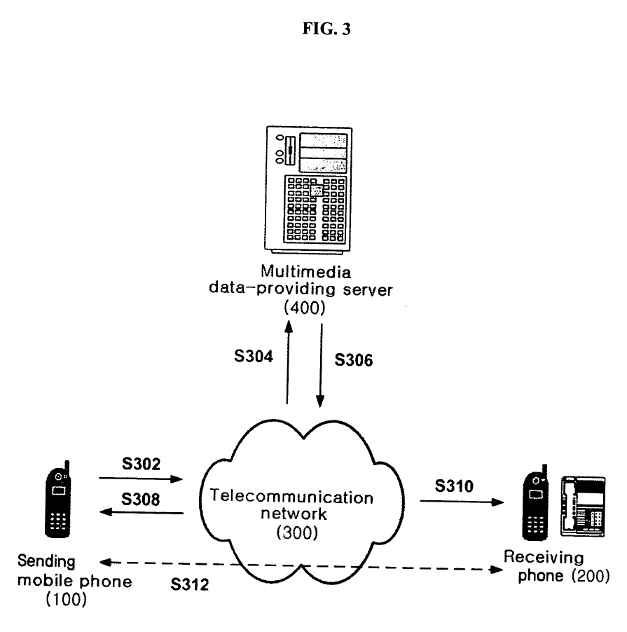

FIGS. 3, 4, 6, and 8 illustrate the present invention according to a second exemplary embodiment, in which, when a phone call is made to a receiving part's phone, multimedia data is automatically downloaded from a multimedia data providing server. According to this embodiment, the type of phone that the receiving part's phone comprises is of no importance. Further, according to this embodiment, the multimedia data has been previously stored in the multimedia data providing server by a user of the receiving part's phone.

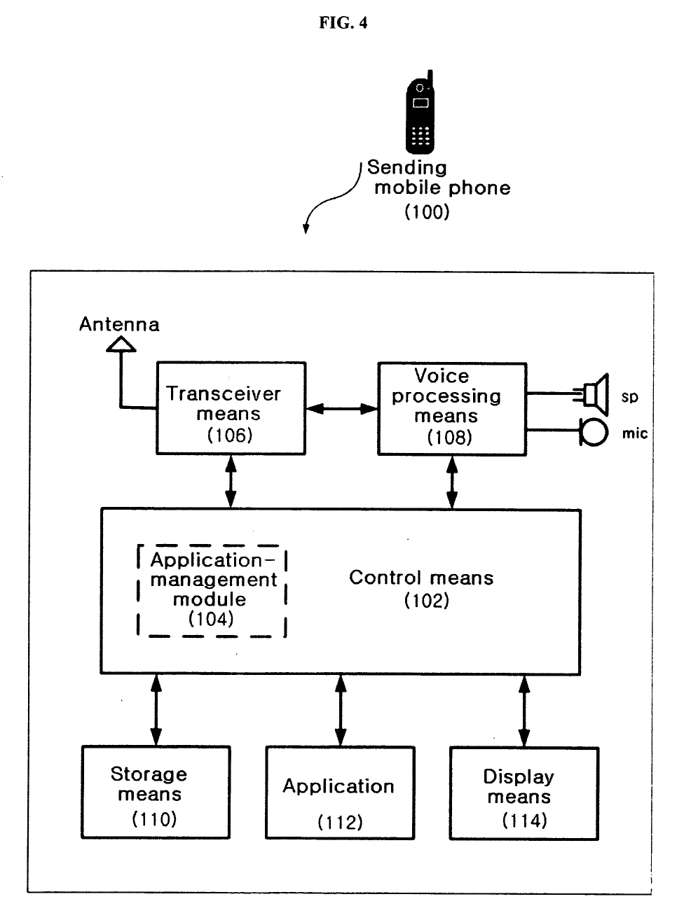

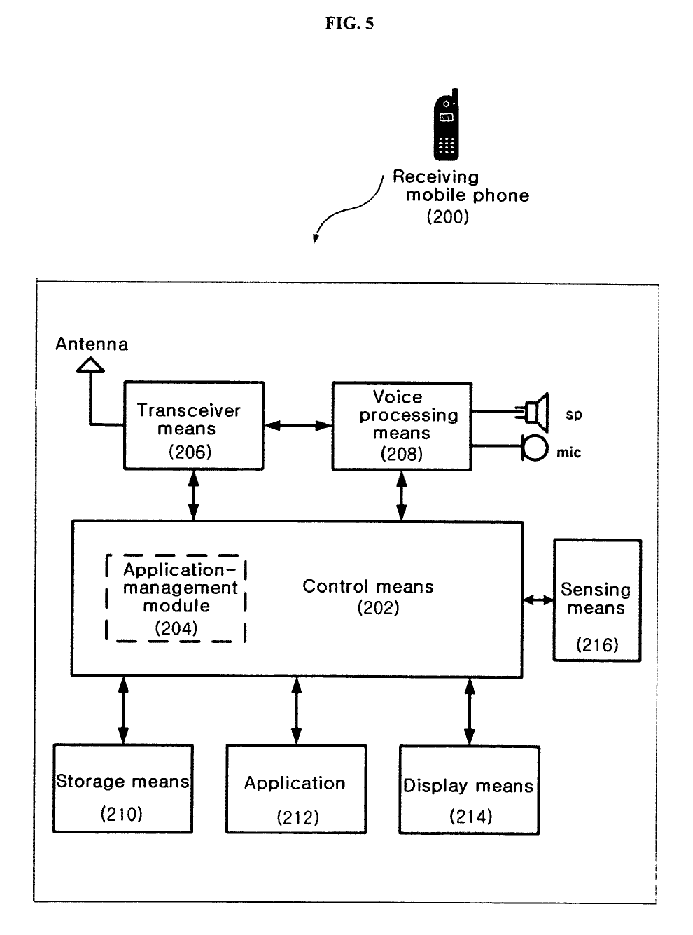

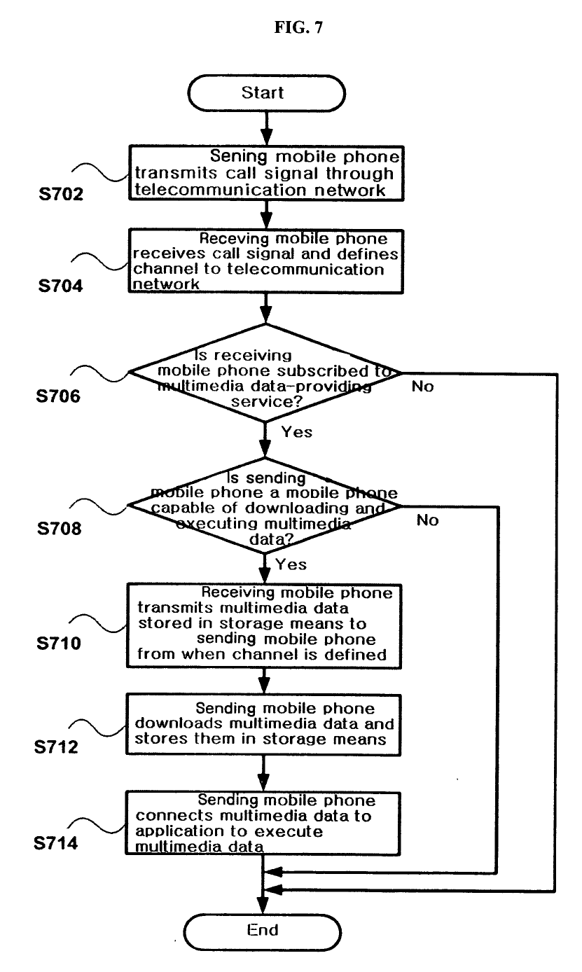

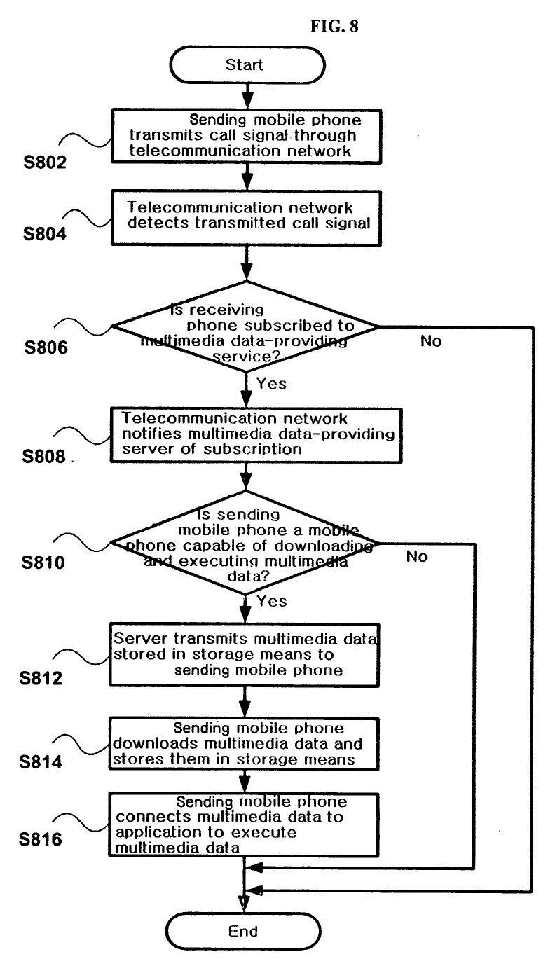

The first exemplary embodiment of the present invention will be described with exemplary reference to FIGS. 2, 4, 5 and 7. FIG. 2 shows operations of a system for downloading the multimedia data from the receiving part's mobile phone according to the first exemplary embodiment of the present invention. FIG. 4 is a block diagram showing a configuration of a sending part's mobile phone for downloading the multimedia data according to the first and second exemplary embodiments of the present invention. FIG. 5 is a block diagram of the receiving part's mobile phone that is subscribed to a multimedia data-providing service and which automatically transmits the multimedia data according to the first exemplary embodiment of the present invention. FIG. 7 is a flowchart illustrating a method of automatically downloading the multimedia data from the receiving part's mobile phone according to the first exemplary embodiment of the present invention.

As shown in FIG. 2, a system, according to the first exemplary embodiment, comprises a sending part's mobile phone 100, a receiving part's mobile phone 200, and a telecommunication network 300. As shown in FIGS. 4 and 5, the sending and receiving part's mobile phones 100 and 200 each comprise a transceiver means 106 or 206, a voice processing means 108 or 208, a storage means 110 or 210, an application 112 or 212, an application-management module 104 or 204, a display means 114 or 214, and a control means 102 or 202. As shown in FIG. 5, the receiving part's mobile phone 200 further comprises a sensing means 216.

Transceiver means 106 or 206 receives a radio signal input through an antenna and a radio call signal separated through a duplexer (not shown), and filters and amplifies a radio call signal output from the voice processing means 108 or 208. The transceiver means 106 or 206 then transmits the radio call signal through the duplexer and through the antenna, under the control of the control means 102 or 202. Further, the transceiver means 206 of the receiving part's mobile phone 200 transmits multimedia data stored in the storage means 210. The transceiver means 106 of the sending part's mobile phone 100 can receive the multimedia data transmitted by the transceiver means 206.

The voice processing means 108 or 208, under the control of the control means 102 or 202, modulates a voice signal input through a microphone MIC into radio data, demodulates the radio signal received through the transceiver means 106 or 206, and transmits the demodulated signal to a speaker SP. Further, when a ring signal is generated from a base station, the voice processing means senses the ring signal through the transceiver means 106 or 206 and then transmits it through a ringer.

The storage means 110 or 210 stores a predetermined control program for controlling the operations of the sending or receiving parts' mobile phone 100 or 200. The storage means 210 of the receiving part's mobile phone 200 stores the multimedia data configured by the user of the receiving part's mobile phone. The storage means 110 of the sending part's mobile phone 100 stores data downloaded from the receiving part's mobile phone 200.

The application 112 or 212 executes the output of the downloaded multimedia data. The display means 114 or 214 can display a variety of information on the mobile phone 100 or 200 under the control of the control means 102 or 202.

The control means 102 or 202 controls the operations of all the components of the mobile phone 100 or 200 and includes the application-management module 104 or 204. The control means 102 of the sending part's mobile phone 100 determines, through the telecommunication network 300, whether the receiving part's mobile phone 200 is subscribed to the multimedia data-providing service. The control means 202 of the receiving part's mobile phone 200 configures the multimedia data-providing service and determines, through the telecommunication network 300, whether the sending part's mobile phone 100 is a mobile phone capable of downloading and executing the multimedia data.

The application management module 104, of the sending part's mobile phone 100, categorizes the downloaded data according to kind or type. The application management module 104 then connects the categorized data with the appropriate application 112 and manages and controls the chosen application 112.

The sensing means 216 senses when the receiving part's mobile phone 200 defines a channel to the telecommunication network 300 and outputs the sensed results to the control means 202.

The operations performed by the aforementioned components, according to the first exemplary embodiment of the present invention, will be described with reference to FIGS. 2 and 7.

First, the transceiver means 106 of the sending part's mobile phone I 00 transmits a call signal through the telecommunication network 300 (S202, S702). The telecommunication network 300 comprises base stations (not shown), base station control apparatuses (not shown), a switch (not shown), a home location register (HLR), a visitor location register (VLR), and the like. The switch of the telecommunication network 300 perceives the state of the receiving part's mobile phone 200 through the HLRIVLR, handles a paging request for tuning a traffic channel between the receiving part's mobile phone 200 and the receiving part's base station, and transmits a primary ringback tone to the sending part's mobile phone 100 until the receiving part's mobile phone 200 issues a paging response. Further, the receiving part's mobile phone 200 defines a channel to the telecommunication network 300 by issuing the paging response (S204, S704).

The control means 102 of the sending part's mobile phone 100 determines, through the telecommunication network 300, whether the receiving part's mobile phone 200 is subscribed to the multimedia data-providing service (S706). If it is determined that the receiving part's mobile phone 200 is subscribed to the multimedia data-providing service, the control means 202, of the receiving part's mobile phone 200, also determines through the telecommunication network 300 whether the sending part's mobile phone 100 is capable of downloading and executing the multimedia data (S708). If it is determined that the receiving part's mobile phone 200 is not subscribed to the multimedia data-providing service, a general call processing procedure is performed.

The user of the receiving part has previously stored the multimedia data in the storage means 210 of his/her own mobile phone 200. In order to store the multimedia data, the user of the receiving part can connect with an ARS server or web server, download the multimedia data, and cause the downloaded multimedia data to be stored. Thus, the receiving part's mobile phone 200 transmits the multimedia data, previously configured and stored in the storage means 210 by the user of the receiving part's mobile phone, to the transceiver means 106, of the sending part's mobile phone 100, from when the receiving part's mobile phone 200 issues the paging response and defines the channel to the telecommunication network 300 (S206, S710). If the sensing means 216 senses when the channel is defined and outputs the sensed results to the control means 202, the control means 202 can perform control for transmitting the multimedia data to the sending part's mobile phone 100. Further, when the receiving part's mobile phone issues the paging response, the switch transmits a ring signal to the receiving part's mobile phone 200 and a secondary ringback tone to the sending part's mobile phone 100. When the user in the receiving part answers by hooking up the mobile phone, the secondary ringback tone is stopped and the user talks over the phone with the caller.

If the multimedia data stored in the storage means 210 of the receiving part's mobile phone 200 are updated, the control means 202 performs control for transmitting the updated data to the transceiver means 106 of the sending part's mobile phone 100.

Further, the control means 202 performs control for transmitting the multimedia data to the transceiver means 106 of the sending part's mobile phone 100 even when the user of the receiving part's mobile phone 200 is talking over the phone with a third person. Here, the multimedia data may be transmitted to the sending part's mobile phone 100 through-an additional channel different from a traffic channel defined between the user of the receiving part's mobile phone and the third person or through a newly defined channel to the sending part's mobile phone 100 after the conversation by phone with the third person is interrupted.

In a case where the multimedia data are not completely transmitted due to their large size even though the receiving part's mobile phone 200 is hooked up and a bi-directional traffic channel is defined, the control means 202 performs control for continuously transmitting the multimedia data to the sending part's mobile phone 100 even after the traffic channel to the sending part's mobile phone 100 is defined. To this end, the multimedia data can be transmitted to the sending part's mobile phone 100 through an additional channel different from the traffic channel that is defined while the recipient talks over the phone with the caller.

Through the processes described above, the sending part's mobile phone 100 downloads the multimedia data and stores them in the storage means 110 (S208, S712).

In addition to this, the both mobile phones 100 and 200 define the bi-directional traffic channel and allow the conversation by phone (S210).

The sending part's mobile phone 100 that has downloaded the multimedia data connects the multimedia data with the application 112 to execute them, under the control of the application-management module 104 (S714).

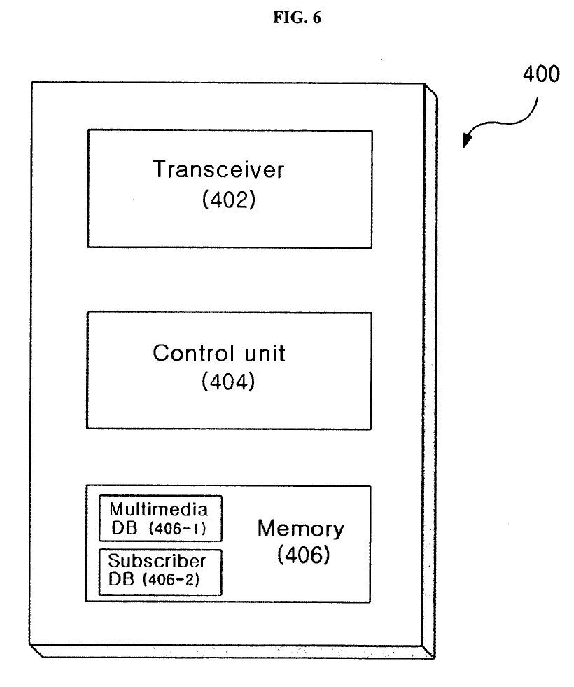

The second exemplary embodiment of the present invention will be described with exemplary reference to FIGS. 3, 4, 6 and 8. FIG. 3 shows operations of a system for downloading multimedia data from the multimedia data-providing server according to the second exemplary embodiment of the present invention. FIG. 4 is a block diagram of the sending part's mobile phone for downloading the multimedia data as described above. FIG. 6 is a block diagram of the multimedia data-providing server according to the second exemplary embodiment of the present invention. FIG. 8 is a flowchart illustrating a method of automatically downloading the multimedia data from the multimedia data-providing server according to the second exemplary embodiment of the present invention.

As shown in FIG. 3, the system, according to the second exemplary embodiment comprises the sending part's mobile phone 100, a receiving part's phone 201, the telecommunication network 300, and the multimedia data-providing server 400. The sending part's mobile phone 100 can have the configuration illustrated in FIG. 4 and described above. The receiving part's phone 201 may be a general wired telephone other than the mobile phone capable of directly transmitting the multimedia data, contrary to the first embodiment. The multimedia data-providing service is configured in the multimedia data-providing server 400 so that the sending part's mobile phone 100 can download and execute the multimedia data.

The multimedia data-providing server 400 determines, through the telecommunication network 300, whether the sending part's mobile phone 100 is capable of downloading and executing the multimedia data. The server 400 also transmits the multimedia data, which have been configured and stored by the user of the receiving part's phone 201, to the sending part's mobile phone 100. The receiving part's phone 201 is subscribed to the service. As shown in FIG. 6, the server 400 comprises a transceiver unit 402, a control unit 404, and a memory 406. The memory 406 comprises a multimedia database 406-1 and a subscriber database 406-2.

That is, the memory 406 comprises the multimedia database 406-1 for storing the multimedia data, previously configured by the user of the receiving part's phone 201, and the subscriber database 406-2 for storing information on subscribers to the multimedia data-providing service.

The transceiver unit 402 transmits the multimedia data, which have been configured and stored in the memory 406 by the user of the receiving part's phone 201, to the sending part's mobile phone 100.

The control unit 404 performs registration, change, deletion, and the like of a service subscriber. The control unit 404 also determines, through the telecommunication network 300, whether the sending part's mobile phone 100 is capable of downloading and executing the multimedia data.

The server 400 may be constructed to be interlocked with the switch in the telecommunication network 300 or may be separately constructed at the outside of the network to be interlocked with other information providing systems such as the Internet. The server 400 may be any type of server including a web server and an ARS server.

The telecommunication network 300 in FIG. 3 defines a channel by connecting a call signal transmitted from the sending part's mobile phone 100 to the receiving part's phone. The network 300 also detects the transmitted call signal and determines whether the receiving part's phone 201 is subscribed to the multimedia data-providing service. If it is determined that the receiving part's phone 201 is subscribed to the service, the network notifies the server 400 of the determination results.

The operations performed by the above components according to the second exemplary embodiment of the present invention will be described with reference to FIGS. 3 and 8.

First, the transceiver means 106 of the sending part's mobile phone 100 transmits a call signal through the telecommunication network 300 (S302, S802). As described in connection with the first exemplary embodiment, the telecommunication network 300 comprises the base stations (not shown), the base station control apparatuses (not shown), the switch (not shown), the home location register (HLR), the visitor location register (VLR), and the like.

The telecommunication network 300 detects the transmitted call signal (S804) and determines whether the receiving part's phone 201 is subscribed to the multimedia data-providing service (S806). If it is determined that the receiving part's phone 201 is not subscribed to the service, the network considers the receiving part's phone as a non-subscriber and performs a general call processing procedure.

If it is determined that the receiving part's phone 201 is subscribed to the service, the network 300 notifies the server 400 of the fact that the phone 201 is subscribed to the service (S304, S808).

After the control unit 404 of the server 400 receives the notification from the network, the control unit 404 determines, through the telecommunication network 300, whether the sending part's mobile phone 100 is capable of downloading and executing the multimedia data (S810).

The user of the receiving part's phone has previously stored the multimedia data in the multimedia database 406-1 of the memory 406 of the server 400. In order to store the multimedia data, the user may configure and register a desired video or audio file in the server 400 through the telecommunication network by using his/her phone 201, may download a desired multimedia file and store them in the server 400 through the wireless Internet, or may configure and register them through the ARS.

If it is determined that the sending part's mobile phone 100 is capable of downloading and executing the multimedia data, the server 400 transmits the multimedia data, which have been already configured and stored in the memory 406 by the user of the receiving part's phone, to the transceiver 106 of the sending part's mobile phone 100 (S306, S812). Such transmission by the server 400 is made before the receiving part's phone 201 issues a paging response to the switch of the telecommunication network 300 and before it defines a channel to the telecommunication network 300.

At this time, if the multimedia data stored in the memory 406 are updated, the control unit 404 of the multimedia data-providing server 400 performs control for transmitting the updated multimedia data to the transceiver 106 of the sending part's mobile phone 100.

The control unit 404 performs control for transmitting the multimedia data to the transceiver 106 of the sending part's mobile phone 100 even when the user of the receiving part's phone 201 is talking over the phone with a third person. In such a case, the server 400 transmits the multimedia data through a defined bi-directional traffic channel.

In a case where the multimedia data are not completely transmitted due to their large size even though the receiving part's phone 201 is hooked up and the bi-directional traffic channel is defined, the control unit 404 performs control for continuously transmitting the multimedia data to the sending part's mobile phone 100 even after the traffic channel is defined. The transmission of the multimedia data is performed through a separate channel by the server 400.

Even in a case where the receiving part's phone 201 is turned off, the channel between the server 400 and the sending part's mobile phone 100 still remains so that the control unit 404 can perform the control for transmitting the multimedia data to the transceiver means 106 of the sending part's mobile phone 100.

Through such processes, the sending part's mobile phone 100 can download the multimedia data and store them in the storage means 110 (S308, S814).

Apart from this, the telecommunication network 300 transmits a ring signal to the receiving part's phone 201 through a paging process (S3 10). Further, the both users of the mobile phones 100 and 201 can talk over the phone through the defined traffic channel (S312).

The sending part's mobile phone 100 that has downloaded the multimedia data connects the multimedia data to the application 112 under the control of the application-management module 104 (S816). Here, the receiving part's phone 201 may be any type of phone including a mobile phone, a general wired/wireless telephone, or a PDA phone. The multimedia data may be video, still images, maps, name cards, personal profiles, music, business advertisements, or the like.

As described above, the user of the sending part's mobile phone is able to download and execute a variety of multimedia information, such as information on video, still images, maps, name cards, personal profiles, business advertisements, or the like in his/her own mobile phone by simply making a phone call.

According to the present invention constructed as above, the multimedia data are transmitted before the bi-direction traffic channel is defined between the mobile phones so that there is no limitation in conversation by phone. Further, in the case where the multimedia data are not completely transmitted due to their large size, the multimedia data are continuously transmitted even after the bi-directional traffic channel is defined. The user of the sending part's mobile phone can download the multimedia data regardless of whether the user of the receiving part's phone talks over the phone or is absent.

Moreover, since the application-management module of the sending part's mobile phone connects the downloaded multimedia data to an executable application, a variety of multimedia data formats can be supported.

Accordingly, the user of the sending part's mobile phone automatically downloads the multimedia data to his/her own mobile phone by only making a phone call to the receiving part's mobile phone that is subscribed to a multimedia data-providing service and stores the multimedia data therein.

Furthermore, the user of the receiving part's phone configures the multimedia data in the multimedia data server rather than his/her mobile phone so that the multimedia data can be automatically downloaded from the server regardless of the kind of receiving part's phone.

Although the above exemplary embodiments of the present invention have been described, it will be understood by those skilled in the art that the present invention should not be limited to the described exemplary embodiments, but that various changes and modifications can be made with in the spirit and scope of the present invention. Accordingly, the scope of the present invention is not limited to the described range of the following claims.

What is claimed is:

1. A sending mobile phone comprising:
a transceiver means for transmitting a call signal to a receiving mobile phone through a telecommunication network and for receiving multimedia data stored in a storage means of said receiving mobile phone;
a storage means for storing said received multimedia data;
an application for executing said multimedia data to be output; and
a control means for determining whether said receiving mobile phone is subscribed to a multimedia data-providing service,
wherein said control means comprises an application-management module for determining the kind of multimedia data, connecting said multimedia data to said application, and managing and controlling said application.

2. A receiving mobile phone subscribed to a multimedia data-providing service, comprising:
a sensing means for sensing when a channel to a telecommunication network is defined;
a storage means for storing multimedia data configured by a user of said receiving mobile phone;
a transceiver means for receiving a call signal from a transceiver means of a sending mobile phone or for transmitting said multimedia data stored in said storage means to said sending mobile phone; and
a control means for configuring the multimedia data-providing service and for determining whether said sending mobile phone is capable of downloading and executing said multimedia data.

3. The receiving mobile phone according to claim 2, wherein if said multimedia data stored in said storage means of the receiving mobile phone are updated, said control means of the receiving mobile phone performs control for transmitting the updated multimedia data to said transceiver means of said sending mobile phone.

4. The receiving mobile phone according to claim 2, wherein said control means of the receiving mobile phone performs control for transmitting said multimedia data to said transceiver means of said sending mobile phone even when a user of the receiving mobile phone is talking on said receiving mobile phone.

5. The receiving mobile phone according to claim 2, wherein said control means of the receiving mobile phone performs control for continuously transmitting said multimedia data to said transceiver means of said sending mobile phone even after the receiving mobile phone is hooked up and a bi-directional traffic channel is defined.

6. A telecommunication system, comprising:
a multimedia data-providing server for determining whether a sending mobile phone is capable of downloading and executing multimedia data, and for transmitting said multimedia data, previously stored by a user of a receiving phone, to said sending mobile phone;
said receiving phone for configuring a multimedia data-providing service and for registering said multimedia data-providing service in said multimedia data-providing server;
said sending mobile phone for downloading said multimedia data, previously configured and stored in said multimedia data-providing server, and of connecting said downloaded multimedia data to an application to execute said multimedia data; and
a telecommunication network for connecting a call signal transmitted from said sending mobile phone to said receiving phone so as to define a channel, and for detecting said transmitted call signal and then determining whether said receiving phone is subscribed to said multimedia data-providing service,
wherein if it is determined that said receiving phone is subscribed to said multimedia data-providing service, said telecommunication network notifies said multimedia data-providing server that said receiving phone is subscribed to said data-providing service.

7. The telecommunication system according to claim 6, wherein said multimedia data-providing server comprises:
a memory for storing said multimedia data, previously configured by said user of said receiving phone, and information on subscribers to said multimedia data-providing service;
a control unit for determining whether said sending mobile phone is capable of downloading and executing said multimedia data; and
a transceiver for transmitting said multimedia data, previously configured and stored in said memory by said user of said receiving phone, to said sending mobile phone.

8. The telecommunication system according to claim 7, wherein if said multimedia data stored in said memory are updated, said control means performs control for transmitting said updated multimedia data to said sending mobile phone.

9. The telecommunication system according to claim 7, wherein said control means performs control for transmitting said multimedia data to said sending mobile phone even when said user of said receiving phone is talking on said receiving phone.

10. The telecommunication system according to claim 7, wherein said control means performs control for continuously transmitting said multimedia data to said sending mobile phone even after said receiving phone is hooked up and a bidirectional traffic channel is defined.

11. The telecommunication system according to claim 7, wherein said control means performs control for transmitting said multimedia data to said sending mobile phone even when said receiving phone is turned off.

12. The telecommunication system according to claim 6, wherein said receiving phone is a mobile phone, a general wired/wireless phone, or a PDA phone.

13. The telecommunications system according to claim 6, wherein said multimedia data comprises at least one of video, still images, maps, name cards, personal profiles, music, and business advertisements.

14. The sending mobile phone according to claim 1, wherein said multimedia data comprises at least one of video, still images, maps, name cards, personal profiles, music, and business advertisements.

15. The receiving mobile phone according to claim 2, wherein said multimedia data comprises at least one of video, still images, maps, name cards, personal profiles, music, and business advertisements.

16. A method of automatically downloading multimedia data from a receiving mobile phone to a sending mobile phone, comprising:
transmitting, by a transceiver means of the sending mobile phone, a call signal through a telecommunication network;
receiving, by a transceiver means of the receiving mobile phone, said call signal transmitted through said telecommunication network and defining a channel to said telecommunication network;
transmitting, by the receiving part's mobile phone, the multimedia data previously configured and stored in a storage means of the receiving part's mobile phone by a user of the receiving part's mobile phone to said transceiver means of the sending mobile phone after said channel is defined; and
downloading said transmitted multimedia data and storing said transmitted multimedia data in a storage means of the sending mobile phone.

17. The method according to claim 16, wherein the receiving operation further comprises:
if it is determined that the receiving mobile phone is subscribed to a multimedia data-providing service, determining whether the sending mobile phone is capable of downloading and executing said multimedia data.

18. The method according to claim 16, wherein the transmitting operation further comprises:
if said multimedia data stored in said storage means of the receiving mobile phone are updated, transmitting said updated multimedia data to said transceiver means of the sending mobile phone.

19. The method according to claim 16, wherein the transmitting operation further comprises transmitting said multimedia data to said transceiver means of the sending mobile phone even when said user of the receiving mobile phone is talking on the receiving mobile phone.

20. The method according to claim 16, wherein the transmitting operation further comprises continuously transmitting said multimedia data to said transceiver means of the sending mobile phone even after the receiving mobile phone is hooked up and a bi-directional traffic channel is defined.

21. The method according to claim 16, wherein the downloading operation further comprises downloading, by the sending mobile phone, said transmitted multimedia data and connecting the multimedia data to an application to execute the multimedia data.

22. A method for automatically downloading multimedia data from a multimedia data-providing server in a telecommunication system, comprising:
transmitting, by a transceiver means of a sending mobile phone, a call signal through a telecommunication network;
detecting, by said telecommunication network, said transmitted call signal and notifying the multimedia data-providing server of the detection results;
transmitting, by the multimedia data-providing server, the multimedia data, previously configured and stored in the server by a user of the receiving part's phone, to said transceiver means of said sending mobile phone in response to said notification; and
downloading, by said transceiver means of said sending mobile phone, the multimedia data transmitted from the multimedia data-providing server and storing the multimedia data in a storage means of said sending mobile phone.

23. The method according to claim 22, wherein the detecting operation further comprises:
after said telecommunication network detects said transmitted call signal, determining whether said receiving phone is subscribed to a multimedia data-providing service; and
if it is determined that said receiving phone is subscribed to said multimedia data-providing service, notifying the multimedia data-providing server that said receiving phone is subscribed to said multimedia data-providing service.

24. The method according to claim 23, wherein the transmitting operation further comprises:
after the multimedia data-providing server receives said notification, determining whether said sending mobile phone is capable of downloading and executing the multimedia data; and
transmitting the multimedia data to said transceiver means of said sending mobile phone.

25. The method according to claim 22, wherein the transmitting operation further comprises:
if the multimedia data stored in the multimedia data-providing server are updated, transmitting said updated multimedia data to said transceiver means of said sending mobile phone.

26. The method according to claim 22, wherein the transmitting operation further comprises transmitting the multimedia data to said transceiver means of said sending mobile phone even when a user of said receiving phone is talking on said receiving phone.

27. The method according to claim 22, wherein the transmitting operation further comprises continuously transmitting the multimedia data to said transceiver means of said sending mobile phone even after said receiving phone is hooked up and a bi-directional traffic channel is defined.

28. The method according to claim 22, wherein the transmitting operation further comprises transmitting the multimedia data to said sending mobile phone even when said receiving phone is turned off.

29. The method according to claim 22, wherein the downloading operation further comprises downloading, by said sending mobile phone, said transmitted multimedia data and connecting said transmitted multimedia data to an application to execute said transmitted multimedia data.

30. The method according to claim 22, wherein said receiving phone is a mobile phone, a general wired/wireless phone, or a PDA phone.

31. The method according to claim 22, wherein said multimedia data comprises at least one of video, still images, maps, name cards, personal profiles, music, and business advertisements.

32. The method according to claim 16, wherein said multimedia data comprises at least one of video, still images, maps, name cards, personal profiles, music, and business advertisements.
